(19) United States
(12) Patent Application Publication
(10) Pub. No.: US 2009/0125727 A1
(43) Pub. Date: May 14, 2009

(54) METHOD FOR CRYPTOGRAPHIC PROCESSING OF A MESSAGE

(75) Inventors: Robert Naciri, Chatenay Malabry (FR); Arnaud Boscher, Puteaux (FR)

Correspondence Address: YOUNG & THOMPSON, 209 Madison Street, Suite 500, ALEXANDRIA, VA, 22314, US

(73) Assignee: OBERTHUR TECHNOLOGIES, PARIS (FR)

(21) Appl. No.: 12/116,236

(22) Filed: May 7, 2008

(30) Foreign Application Priority Data
May 7, 2007 (FR) 0754912

(51) Int. Cl. G06F 12/14

(52) U.S. Cl. 713/189

(57) ABSTRACT

A method for cryptographic processing of a message by a secret key includes the following steps:
determination of a third data item (a₀) and a fifth data item (a₁⊕eCtrl), including calculation, as a function at least of a first data item (m) obtained from the message and a second data item (d) obtained from the secret key, of the third data item (a₀) and a fourth data item (a₁) linked by a verification relationship, and including obtaining the fifth data item (a₁⊕eCtrl) by combination of the fourth data item (a₁) and a data item (eCtrl) representing the second data item (d);
verification of the verification relationship between the third data item and a combination of the fifth data item and the second data item.

The invention concerns a method for cryptographically processing a message by means of a secret key.

In cryptography, messages are commonly processed by means of a secret key, which is stored in a microcircuit card, for example. Such processing is carried out in the context of the holder of the secret key (i.e. the cardholder) signing the message, for example, or in the context of decrypting the message if it is sent to the holder of the secret key (in which case the message has been encrypted beforehand, for example by means of a public key associated with the secret key).

Processing the message generally consists in performing a calculation in which the message and the secret key are considered as numbers. Thus the RSA algorithm applies the secret key to the message by means of a modular exponentiation operation.

Because of this, this type of operation is the target of attacks by malicious users seeking to discover the secret key, generally with a view to using it fraudulently.

Countermeasures have therefore been adopted to combat attacks that can be envisaged, for example masking the numbers used as described in patent application FR 2 675 355 in the context of implementing the RSA algorithm using the Chinese remainder theorem (CRT).

To combat fault generation attacks that disrupt the execution of the cryptographic algorithm in order to attempt thereby to deduce information regarding the secret key, it has been proposed to verify correct execution of the cryptographic algorithm by carrying out a complementary calculation, as described in patent application FR 2 867 635, for example.

In the context of the RSA algorithm, such verification can be carried out, after exponentiation by the secret key, by applying exponentiation by the associated public key in order to verify that the original message is obtained. This technique is somewhat inefficient from the calculation time point of view, however, and necessitates a knowledge of the public key, which is not always the case.

This is why it is proposed, in patent application FR 2 884 004, to update two complementary variables throughout the modular exponentiation calculation and to verify a relationship normally existing at all times between those two variables at the end of the calculation in order to be sure that no fault has occurred.

The inventors of the present invention have noted, however, that the proximity of these two variables enables attacks that do not call into question the existing relationship between them, for example by modifying the secret key during the modular exponentiation calculation.

To address this problem in particular, the invention proposes a method for cryptographic processing of a message by means of a secret key, characterized in that it comprises the following steps:
determination of a third data item and a fifth data item, including calculation, as a function at least of a first data item obtained from the message and a second data item obtained from the secret key, of the third data item and a fourth data item linked by a verification relationship, and including obtaining the fifth data item by combination of the fourth data item and a data item representing the second data item;
verification of the verification relationship between the third data item and a combination of the fifth data item and the second data item.

This provides assurance not only as to the consistency of the result of the calculation but also as to the integrity of the data (the second data item) derived from the secret key, which is beneficial in particular if the relationship is independent of the secret key.

To further strengthen protection against attacks, there can be provided a step of reading the second data item in a nonvolatile memory between the determination step and the verification step. Thus the verification step is carried out with a second data item that has been read anew, for example in non-volatile memory.

In the embodiment described hereinafter, the third data item can be used as a result in the event of positive verification in the verification step.

In this embodiment, the calculation of the third data item and the fourth data item comprises at least one step of modifying the third data item or the fourth data according to whether a bit of the second data item has the value 0 or 1.

There can then further be provision for modifying the data item representing the second data item in each modification step in such a manner as to store the bit of the second data item used in the step concerned.

The representative data item can be modified in such a manner as to store said bit after the modification step using said bit, for example, which stores the bit actually used.

In practice, there can be provision for the representative data item to be modified by multiplication by two followed by addition of said bit.

In one possible embodiment, the representative data item can be stored in the register storing the second data item, in particular because space is freed up in that register as and when the modification steps are iterated.

The verification relationship is one of modular equality between said combination and the product of the third data item and the message, for example.

Moreover, the combination can be an exclusive-OR operation, which is particularly practical to use.

The process as a whole can comprise steps conforming to the Chinese remainder theorem (CRT), as explained hereinafter.

The invention also proposes a method for cryptographic processing of a message by means of a secret key, comprising a step of:
calling a routine using for parameters at least a first data item obtained from the message and a second data item obtained from the secret key, the routine calculating, as a function of the parameters received, a third data item and a fourth data item linked by a verification relationship, characterized in that the routine returns the third data item and a fifth data item obtained by combining the fourth data item and a data item representing the second data item as received by the routine, and in that the process comprises a step of:
verification of the verification relationship between the third data item and a combination of the fifth data item and the second data item.

The method described hereinabove is particularly advantageous against an attack aiming to modify the values entered as parameters on calling the routine (or sub-program).

The optional features envisaged hereinabove apply in a similar manner here and will therefore not be repeated here.

The invention further proposes a method that is novel in itself for cryptographic processing of a message by means of a secret key, in which at least one processing step depends on a group of at least one bit of the secret key, characterized by the following steps:
modification of a control variable in such a manner as to store the group used in the processing step;
comparison of the control variable and at least a portion of the secret key.

An a posteriori verification therefore provides assurance that the bits used during processing corresponded to those of the secret key, which prevents a fault generation attack.

As already mentioned hereinabove, to strengthen the verification referred to above, there can further be provision for a step of reading at least a portion of the secret key in non-volatile memory between the modification step and the comparison step.

Error processing is carried out in the event of a negative verification in the comparison step, for example.

In one embodiment, the processing step can be executed for each bit of the secret key. In this case, the control variable is modified after each processing step by multiplication by two followed by addition of the bit used during the processing step concerned, for example, which is a practical way to store the various bits used during the iteration of the processing steps.

The invention further proposes a method for cryptographic processing of a message by means of a secret key in an electronic entity comprising a non-volatile memory, characterized by the following steps (which are preferably executed in this order, especially with regard to the steps of reading non-volatile memory):
first reading of at least a portion of the secret key in the non-volatile memory;
cryptographic calculation, on the basis of a first data item obtained from the message and a second data item obtained from the secret key read during the first reading, to produce a third data item and a fourth data item linked by a verification relationship;
recombination in accordance with the CRT algorithm involving the third data item and producing a fifth data item;
second reading of at least a portion of the secret key in the non-volatile memory;
recombination in accordance with the CRT algorithm involving the fourth data item and the second data item obtained from the secret key read during the second reading and producing a sixth data item;
verification of said relationship between the fifth data item and the sixth data item.

As already indicated, the optional characteristics envisaged hereinabove with regard to the first cryptographic processing method referred to apply in a similar manner to the other processing methods referred to and will therefore not be repeated here.

Other features and advantages of the invention will become apparent in the light of the following description, given with reference to the appended drawings, in which:

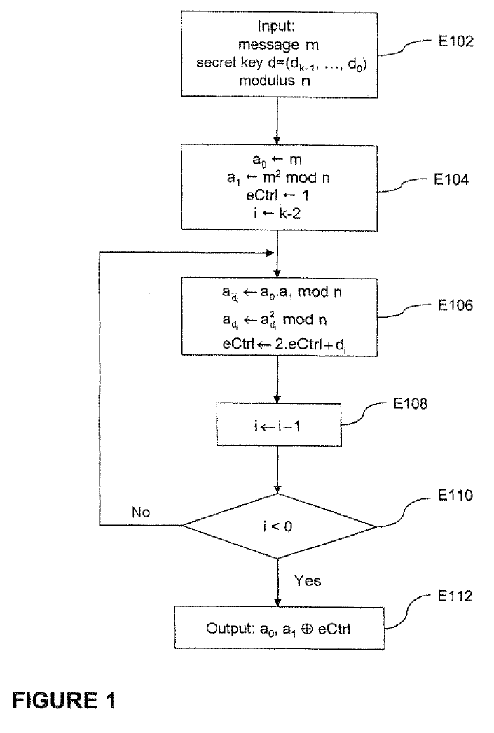

FIG. 1 represents a modular exponentiation routine conforming to the teachings of the invention;

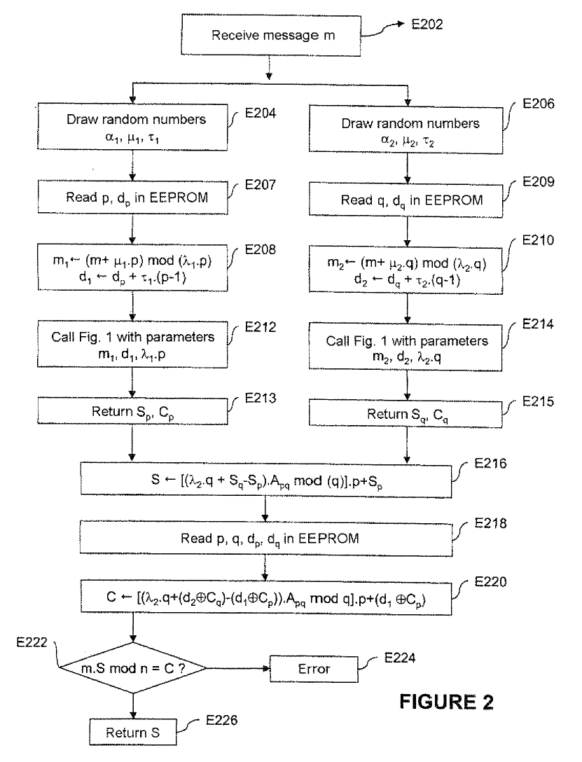

FIG. 2 represents RSA type processing conforming to the teachings of the invention,

The cryptographic processing method whose steps are represented in FIG. 1 is implemented in a microcircuit card, for example, in order to apply to a message m modular exponentiation to the power d using a modulus n.

The message m is represented in numeric form and for the purposes of cryptographic processing is treated as a number. The message m is received via the communication interface of the microcircuit card, for example, and stored in a random access memory thereof.

The exponent d is a secret key stored in a non-volatile memory of the microcircuit card, for example, which is an electrically erasable programmable read-only memory (EEPROM), for example. Hereinafter dᵢ denotes the bits that form the secret key, from dₖ₋₁, the most significant bit, to d₀, the least significant bit (with k=2048, for example).

The modulus n is generally stored in non-volatile memory. The secret key d and the modulus n are transferred into random access memory when they are used in a calculation.

The method represented in FIG. 1 is a routine or sub-program used in the context of the cryptographic processing of the message m in the microcircuit card, for example. The various steps of this routine therefore result from execution by the microprocessor of the microcircuit card of instructions stored in a read-only memory of the microcircuit card (or where applicable in the non-volatile memory referred to hereinabove)

The step E102 represented in FIG. 1 describes the parameters received (or “given”) as input by the routine and on the basis whereof the method represented in FIG. 1 is implemented as described hereinafter. Here the method receives as input the message m, the secret key d and the modulus n.

The microprocessor then commands an initialization step E104 during which the message m is copied into a register (or memory) a₀. Similarly, a register a₁ is set to the value m² mod n, a register eCtrl is set to 1 and a register with the index i is set to the value k-2.

A loop on the value of i then begins in the step E106. On each iteration of the loop, the value a₀·a₁ mod n is written (overwritten) in the register a _{d̅i}, after which the value a_{di}² mod n is written (also overwritten) in the register a_{di}, bearing in mind that dᵢ is the value of the bit with the index i of the secret key d and that d̅ᵢ is the complement of that value.

During the step E106 the value 2·eCtrl+dᵢ is written (overwritten) in the register eCtrl.

There follows the step E108 in which the index i is decremented.

The step E110 tests if i is negative, in which case the process exits the loop in the step E112. On the other hand, if i is positive or zero, there is a loop to the step E106.

Thus the aforementioned loop executes the iteration step E106 for i varying from k-2 to zero, which at the end of the loop produces in the register a₀ the value m^{d} mod n, in the register a₁ the value m·a₀ mod n, and a value eCtrl each bit whereof corresponds to the bit dᵢ actually used during processing and that, in the final analysis, is therefore equal during processing with no faults to the input value of the secret key d.

The value eCtrl is stored in a specific register, for example. Alternatively, it could be stored in the same register as the secret key d, because the bit dᵢ used in each iteration is not used subsequently and can therefore be overwritten. In this case the leftward shift generated by multiplying eCtrl by 2 can in this case be used to work through the bits of the secret key d (instead of the index i mentioned above).

As indicated hereinabove, the exit from the loop is effected in the step E112, in which the sub-program described here returns to the main program that called it, on the one hand, the value of the register a₀ and, on the other hand, the combination by an exclusive-OR (XOR) operator of the value of the register a₁ and the value of the register eCtrl. These return values enable the main program to verify execution without fault in the FIG. 1 routine. If the return values following the step E112 are denoted A and B, for example, the following relationship should be verified in the event of execution without faults (in this relationship the symbol ⊕ denotes the exclusive-OR (XOR) operator):

d⊕B=m·A mod n.

Note that this verification not only provides assurance as to the consistency of the data a₀ and a₁ calculated in the FIG. 1 routine (assuming processing without faults), but also implies that the secret key d used in this sub-program is the required secret key, and not another number substituted by means of a fault generation attack, for example.

This technique could be used in a similar way in elliptical curve asymmetrical key cryptography.

To effect this verification under particularly secure operating conditions, the main program reads the secret key d again in the non-volatile memory of the microcircuit card before the verification of the relationship referred to above, as described next with reference to FIG. 2.

FIG. 2 represents a cryptographic processing method conforming to the teachings of the invention using the Chinese remainder theorem (CRT) method.

In the step E202, the microprocessor of the microcircuit card receives the message m to be processed.

The message m is then processed as described hereinafter in the steps E204 to E216. Although the steps E204 to E215 are represented in two branches in FIG. 2 in order to clarify the explanation, they can be carried out successively, for example in the order of the numbers of the steps.

The method to be described hereinafter obtains the signature of the message m by applying a private key (d, p, q) in accordance with the RSA algorithm.

If the message m were an encrypted message, a method analogous to that to be described would decrypt the message m using this private key.

The numbers p and q are integers that constitute the prime factors of the public modulus (or public key modulus) n. These numbers are used as moduli in the intermediate calculations using the Chinese remainder theorem without masking.

The number d is the exponent of the private key that is linked to the exponent e of the public key by the following relationship: d.e=1 mode [(p−1) (q−1)].

In the example shown in FIG. 2, three integers λ₁, μ₁, τ₁ are used for the calculations relating to the modulus p. The aforementioned integers are obtained by drawing random numbers (step E204), for example, which improves the security of the system. Here “drawing random numbers” naturally means obtaining pseudo-random numbers using standard techniques in this field.

In a similar way, three integers λ₂, μ₂, τ₂ used for the processing relating to the modulus q are determined in the step E206. As indicated with regard to the integers λ₁, μ₁, τ₁, the integers λ₂, μ₂, τ₂ can be obtained by drawing random numbers.

The elements p and dₚ of the secret key (where dₚ=d mod(p−1)) are then read in the non-volatile memory in the step E207. There follows the step E208 that groups together the operations for masking the values used for modular exponentiation in relation to the modulus p.

To this end, the first step is to calculate a first masked message m₁ from the formula m₁=(m+μ₁·p)mod(λ₁·p).

Note that this operation consists on the one hand in masking the message itself by adding to it an integer multiple of the modulus p (μ₁p) and on the other hand in masking the modulus p itself by multiplying it by an integer λ₁.

It is therefore clear that, as indicated hereinabove, using integers λ₁ and μ₁ obtained by drawing random numbers makes masking more effective and thereby enhances the security of the system.

The step E208 also includes an operation of calculating a masked exponent d₁=dₚ+τ₁·(p−1).

This latter operation masks the exponent used during modular exponentiation, as indicated hereinafter.

The elements q and d_{q} (where d_{q}=d mode(q−1)) are then read in the non-volatile memory in the step E209 and there follows the step E210 that performs calculations analogous to those of the step E208, here with reference to the module q:
the modular residue m₂ of the masked message is determined from m₂=(m+μ₂·q)mod(λ₂·q);
the masked exponent d₂ is calculated from d₂=d_{q}+τ₂·(q−1).

Once the values used in the modular exponentiation calculations have been determined in the steps E208 and E210, those calculations can be carried out, as described in detail next.

The step E212 includes modular exponentiation of the masked modular residue m₁ by means of the masked exponent d₁ previously determined, using the masked modulus (λ₁·p) as before, and calling on the sub-program described above with reference to FIG. 1, with the parameters m₁ as the message, d₁ as the secret key, and (λ₁·p) as the modulus. The masked modular result Sₚ relative to the modulus p (here calculated using the masked modulus λ₁·p) received as the first return value therefore has the value:

Sₚ=(m₁)^{d}^{₁}mode(λ₁p.),

whereas the second value Cₚ returned verifies the following relationship in the event of normal execution:

d₁⊕Cₚ=m₁·Sₚ mod(λ₁·p).

Note that, the integer λ₁ being a random number, the masked modular result S₁ is also random, which enhances security.

The masked modular result S_{q} is calculated in a similar way in the step E214 by calling the FIG. 1 routine with m₂ as the message, d₂ as the secret key, and (λ₂·q) as the modulus.

This yields (S_{q}, C_{q}), where: S_{q}=(m₂)^{d}^{₂} mod(λ₂·q) and C_{q} such that d₂⊕C_{q}=m₂·S_{q} mod(λ₂·q)

These operations therefore use the masked modular residue m₂ and the masked exponent d₂ determined in the step E210 as well as the masked modulus (λ₂·q).

The modular results Sₚ and S_{q} having been obtained as explained hereinabove for each of the moduli p and q using the masked moduli (λ₁·p) and (λ₂·q), the signature S is obtained in the step E216 by linear recombination of the modular results according to the following formula, in which A_{pq} is the modular inverse of p modulo q defined by p·A_{pq}=1 mod q:

S=[(λ₂·q+S_{q}−S_{q})·A_{pq} mod(q)]·p+Sₚ.

The recombination formula is of the type just indicated, but could be different from the formula given hereinabove; the following formula could be used instead, for example, where B_{qp} is the modular inverse of q modulo p, such that q·B_{qp}=1 mod p:

S=[(λ₁p+Sₚ−S_{q})·B_{qp}mode(p)]·q+S_{q}.

Elements of the secret key (here all its elements, namely p, q, dₚ and d_{q}) are then read again in non-volatile memory, after which the elements d₁ and d₂ are recalculated as in steps E208 and E210, which verifies the calculations as described hereinafter with the values actually stored in non-volatile memory.

There follows in the step E220 the calculation of a value C such that:

C=[(λ₂·q+(d₂⊕C_{q})−(d₁⊕Cₚ))·A_{pq} mod q]·p+(d₁⊕Cₚ).

Given the properties of the values returned by the FIG. 1 sub-program (i.e. the relationship between them) as explained hereinabove, in the case of operations without faults (which faults could be caused by an attack), the values S and C must satisfy the relationship: m·S mod n=C.

This relationship is therefore verified in the step B222. In the event of a positive verification, the process is considered to have been executed without fault (and therefore without attack) and the value S is returned as the result, for example sent to the exterior of the microcircuit card (step E226).

On the other hand, if the relationship is not verified in the step E222, an error is noted (step E224) and no information on the data used in the process is sent to the exterior when the error is the result of a fault generation attack. An error message that gives no information on the data processed can naturally be sent, however.

The embodiments that have just been described are merely possible examples of implementation of the invention, which is not limited to them.

1. Method for cryptographic processing of a message by means of a secret key, characterized in that it comprises the following steps:
determination of a third data item (a₀) and a fifth data item (a₁⊕eCtrl), including calculation, as a function at least of a first data item (m) obtained from the message and a second data item (d) obtained from the secret key, of the third data item (a₀) and a fourth data item (a₁) linked by a verification relationship, and including obtaining the fifth data item (a₁⊕eCtrl) by combination of the fourth data item (a₁) and a data item (eCtrl) representing the second data item (d);
verification of the verification relationship between the third data item and a combination of the fifth data item and the second data item.

2. Processing method according to claim 1, characterized in that the relationship is independent of the secret key.

3. Processing method according to claim 1, characterized by a step of reading the second data item in a non-volatile memory between the determination step and the verification step.

4. Processing method according to claim 1, characterized by a step of using the third data item as the result in the case of a positive verification in the verification step.

5. Processing method according to claim 1, characterized in that the calculation of the third data item and the fourth data item comprises at least one step of modifying the third or fourth data item according to whether a bit of the second data item has the value 0 or 1.

6. Processing method according to claim 5, characterized in that, in each modification step, the data item representing the second data item is modified in such a manner as to store the bit of the second data item used in the step concerned.

7. Processing method according to claim 6, characterized in that the representative data item is modified in such a manner as to store said bit after the modification step using said bit.

8. Processing method according to claim 6, characterized in that the representative data item is modified by multiplication by two and then by addition of said bit.

9. Processing method according to claim 6, characterized in that the representative data item is stored in the register storing the second data item.

10. Processing method according to claim 1, characterized in that the verification relationship is one of modular equality between said combination and the product of the third data item and the message.

11. Processing method according to claim 1, characterized in that the combination operation is an exclusive-OR operation.

12. Processing method according to claim 1, characterized in that it comprises steps conforming to the Chinese remainder theorem.

13. Method for cryptographic processing of a message by means of a secret key, comprising a step of:
calling a routine using for parameters at least a first data item obtained from the message and a second data item obtained from the secret key, the routine calculating, as a function of the parameters received, a third data item and a fourth data item linked by a verification relationship;
characterized in that
the routine returns the third data item and a fifth data item obtained by combining the fourth data item and a data item representing the second data item as received by the routine;
and in that the process comprises a step of:
verification of the verification relationship between the third data item and a combination of the fifth data item and the second data item.

14. Method for cryptographic processing of a message by means of a secret key, in which at least one processing step depends on a group of at Least one bit from the secret key,
characterized by the following steps:
modification of a control variable in such a manner as to store the group used in the processing step;
comparison of the control variable and at least a portion of the secret key.

15. Processing method according to claim 14, characterized by a step of reading at least a portion of the secret key in non-volatile memory between the modification step and the comparison step.

16. Processing method according to claim 14, characterized by error processing in the case of a negative verification in the comparison step.

17. Processing method according to claim 14, characterized in that the processing step is executed for each bit of the secret key.

18. Processing method according to claim 17, characterized in that the control variable is modified after each processing step by multiplication by two and then by addition of the bit used during the processing step concerned.

19. Method for cryptographic processing of a message by means of a secret key in an electronic entity comprising a non-volatile memory, characterized by the following steps:
first reading of at least a portion of the secret key in the non-volatile memory;
cryptographic calculation, on the basis of a first data item obtained from the message and a second data item obtained from the secret key read during the first reading, producing a third data item and a fourth data item linked by a verification relationship;
recombination in accordance with the CRT algorithm involving the third data item and producing a fifth data item;
second reading of at least a portion of the secret key in the non-volatile memory;
recombination in accordance with the CRT algorithm involving the fourth data item and the second data item obtained from the secret key read during the second reading and producing a sixth data item;
verification of said relationship between the fifth data item and the sixth data item.

20. Processing method according to claim 2, characterized by a step of reading the second data item in a nonvolatile memory between the determination step and the verification step.
